(19) United States
(12) Patent Application Publication
(10) Pub. No.: US 2010/0017176 A1
(43) Pub. Date: Jan. 21, 2010

(54) SYNTHETIC STRUCTURE FOR ASYMMETRIC EDDIES IN THE OCEAN

(75) Inventor: Avijit Gangopadhyay, North Dartmouth, MA (US)

Correspondence Address: Vern Maine & Associates, 100 MAIN STREET, P O BOX 3445, NASHUA, NH, 03061-3445, US

(73) Assignee: UNIVERSITY OF MASSACHUSETTS, North Dartmouth, MA (US)

(21) Appl. No.: 12/506,280

(22) Filed: Jul. 21, 2009

Related U.S. Application Data
(60) Provisional application No. 61/082,323, filed on Jul. 21, 2008.

(51) Int. Cl. G06G 7/48; G06G 7/56

(52) U.S. Cl. 703/5; 703/5

(57) ABSTRACT

A system and method is provided for an asymmetric formulation whereby multiple water masses mix together and generate an ‘eddy-like’ feature. Given the core and the shore profiles, embodiments produce a three-dimensional eddy representation for a particular ocean region based on three (core, inshore and offshore) specified profiles. The formulation employs parameter-based feature models and is generalized to ocean regions having asymmetric eddy water masses. Embodiments apply to regions in the global coastal ocean, providing nowcasting and forecasting in any oceanic region where eddies are part of the overall circulation. Examples of such eddies are off of Cape São Tomé (CST) and Cape Frio (CF) along the southeastern coast of Brazil.

### RELATED APPLICATIONS

This application claims the benefit of U.S. Provisional Application No. 61/082,323, filed Jul. 21, 2008; this application is herein incorporated in its entirety by reference.

### FIELD OF THE INVENTION

The invention relates to ocean circulation features, and more particularly, to modeling asymmetric ocean eddies.

### BACKGROUND OF THE INVENTION

Ocean circulation features have a significant impact on activities in their proximity. As activity has expanded in the oceans, so has the importance of understanding these circulation features. Naval activities and offshore industries such as cable-laying and oil extraction have a need for predictive modeling of these features. For example, the Brazil oil industry has over fifty intrinsically risk-prone offshore platforms and there are tens of thousands of people that work in the area. This degree of investment greatly benefits from risk reduction tools. Predictive modeling tools serve these needs. They can reduce uncertainty by identifying current locations and velocities.

Feature models (FM) are used to predict ocean effects in support of these activities. Feature models are synthetic structures of certain repetitive circulation features in the ocean. Once parameterized, they can be useful for numerical modeling systems to forecast and nowcast (0-12 hour forecasting is often referred to as nowcasting) a particular oceanic region in a four-dimensional (space-time) sense. Parameter-based feature models for vertical structures such as “eddies” in the North Atlantic Ocean have been developed by Gangopadhyay et al (1997) for use in numerical ocean model nowcasting and forecasting. Generalization of such structures for application to other oceanic regions was presented by Gangopadhyay and Robinson (2002). However, these eddies were formulated as having “symmetric” structure; namely, the vortex is symmetric in its temperature and salinity distribution around its center (or core).

Previous formulations were limited in their application to Gulf Stream Rings and symmetric eddies. A need exists for modeling other ocean regions such as the southeastern Brazil (SEBRA) regional ocean to produce reports that can be used to predict conditions for applications involving asymmetric eddies.

### SUMMARY OF THE INVENTION

Embodiments of this invention provide an asymmetric formulation whereby two or three different water masses can mix together and generate an ‘eddy-like’ feature. Temperature-salinity (T-S) profiles are varied by adopting a generalized tracer formulation for the eddy feature model (EFM). The asymmetric formulation includes an equation comprising an asymmetry parameter gamma (γ).

Examples of such eddies are those off of Cape São Tomé (CST) and Cape Frio (CF) along the southeastern coast of Brazil. Embodiments of the present invention provide different values of γ for the Cabo Frio Eddy (CFE) and the Cabo São Tomé eddy (CSTE). Embodiments of the present invention provide seasonal variation of γ.

This approach generalizes the formulation to other ocean regions having asymmetric eddy water masses. Embodiments are useful for any region in the global coastal ocean and are applicable to nowcasting and forecasting in any oceanic region where eddies are part of the overall circulation. They can be used for predicting coastal oceanic regions which have persistent eddy activity. Examples of such regions are the Gulf of Maine, the Gulf of Alaska, the Gulf of Mexico, the Caribbean Sea, the Norwegian Sea, etc.

An embodiment of the invention is a system for representing asymmetric eddy properties, the system comprising an input component that receives hydrographic property profiles comprising inshore, core, and offshore data; a processing component that generates asymmetric eddy properties comprising temperature and salinity from the hydrographic property profiles; and a display component that generates output of the asymmetric eddy properties. For embodiments, the hydrographic property profiles represent at least one region, and the processing component comprises an eddy feature model (EFM). In other embodiments, the processing component comprises a generalized tracer formulation, and the processing component comprises asymmetry parameter gamma (γ). In yet other embodiments, the asymmetry parameter gamma comprises seasonal variations, and the asymmetry parameter gamma comprises regional variations. In another embodiment, the generalized tracer formulation comprises the relationship T(ρ,z,θ)=Tₖ(z,θ)[1−exp(−r/R)]+T_{c}(z)exp(−r/R). For a further embodiment, the processing component comprises an internal Rossby deformation radius. Another embodiment provides that at least one region comprises southeastern Brazil (SEBRA). One embodiment specifies that at least one region comprises at least one of Cabo Frio Eddy (CFE), Cabo São Tomé Eddy (CSTE), and Vitória Eddy (VE). A yet further embodiment specifies that at least one region comprises at least one of Gulf of Maine, Gulf of Alaska, Gulf of Mexico, Caribbean Sea, and Norwegian Sea. For other embodiments, the generated output comprises a nowcast of the asymmetric eddy properties, and the hydrographic property profiles comprise Ecosystem Dynamics of the Continental Shelf Region of the western South Atlantic (DEPROAS) data.

Another embodiment of the invention is a method for representing asymmetric eddy properties, the method comprising the steps of providing asymmetry parameter gamma (γ); providing edge profile information; selecting a feature model (FM); loading an eddy profile; selecting a grid; selecting profile dimension type; implementing asymmetric eddy equation for the asymmetry parameter gamma (γ), the edge profile information, the feature model, the eddy profile, the grid, and the profile dimension type; plotting eddy properties; and generating output from the eddy properties. Other embodiments comprise edge profile information given by Tₖ(z,θ)=Tᵢ(z)+[(Tₒ(z)−Tᵢ(z))/2]exp(θ/γ)(1+cos θ). In other embodiments, the step of selecting a feature model (FM) comprises a Brazil current feature model (BCFM), and the step of selecting a feature model (FM) comprises a mean profile. For yet another embodiment, the generating output step comprises at least one of storing results for future retrieval, displaying results, and printing results.

A further embodiment of the invention provides a method for representing asymmetric eddy properties, the method comprising the steps of providing asymmetry parameter gamma (γ); providing edge profile information comprising relationship Tₖ(z,θ)=Tᵢ(z)+[(Tₒ(z)−Tᵢ(z))/2]exp(θ/γ) (1+cos θ); selecting a Brazil current feature model (BCFM); loading an eddy profile; selecting a grid file; selecting profile dimension type; implementing asymmetric eddy equation for the asymmetry parameter gamma (γ), the edge profile information, the Brazil current feature model, the eddy profile, the grid file, and the profile dimension type, wherein the implementing comprises a generalized tracer formulation T(ρ,z,θ)=Tₖ(z,θ)[1−exp(−r/R)]+T_{c}(z)exp(−r/R); plotting eddy properties comprising temperature and salinity from the equation implementation; and generating output comprising at least one of storing results for future retrieval, displaying results, and printing results.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a map illustrating a region for modeling asymmetric eddies in accordance with one embodiment of the present invention.

FIG. 2 is a schematic diagram of oceanic circulation features off of the southeast coast of Brazil in accordance with one embodiment of the present invention.

FIG. 3 is a schematic diagram of asymmetric eddy modeling parameters configured in accordance with one embodiment of the present invention.

FIG. 4 is a flow chart of a method for estimating asymmetric eddies configured in accordance with one embodiment of the present invention.

FIG. 5 is a graph of temperature lines used to delimit an eddy in accordance with one embodiment of the present invention.

FIG. 6 illustrates an output of results for the Cabo Frio Eddy (CFE) configured in accordance with one embodiment of the present invention.

### DETAILED DESCRIPTION

Some oceanic eddies are not symmetric in their temperature expression. An asymmetric formulation is provided that includes an equation with the asymmetry parameter gamma (γ). The asymmetry parameter will be different for different oceanic regions. The formula, the seasonal variation of γ, and its different values for Cabo Frio Eddy (CFE) and Cabo São Tomé Eddy (CSTE) are included in embodiments of the invention. These were not part of previous studies of Gangopadhyay et al. (1997) or Gangopadhyay and Robinson (2002).

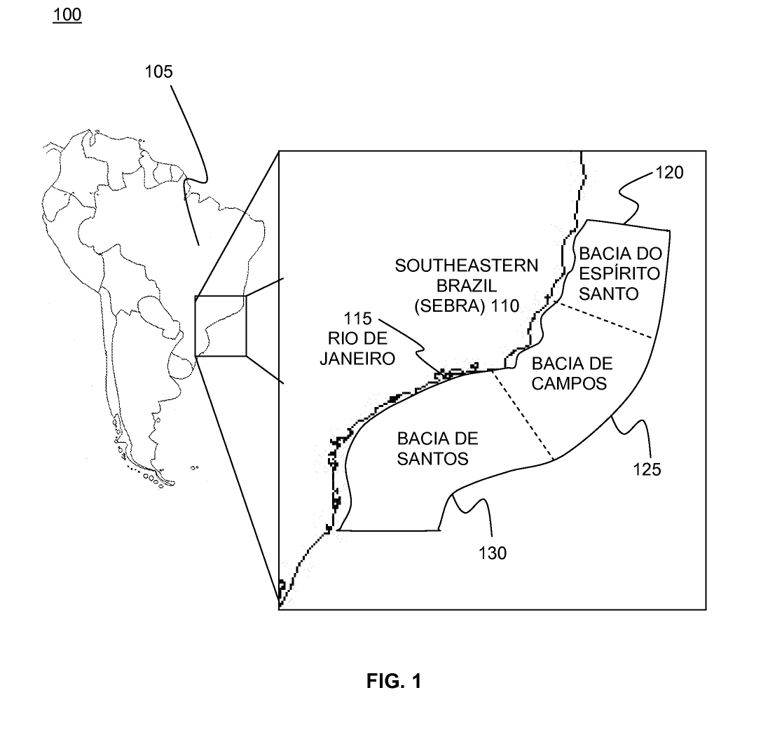

FIG. 1 is a map 100 illustrating Brazil 105 including an enlargement of the southeastern Brazil (SEBRA) ocean region 110 considered in modeling asymmetric eddies. It includes Rio de Janeiro 115, and the three regions Bacia do Espírito Santo 120, Bacia de Campos 125, and Bacia de Santos 130.

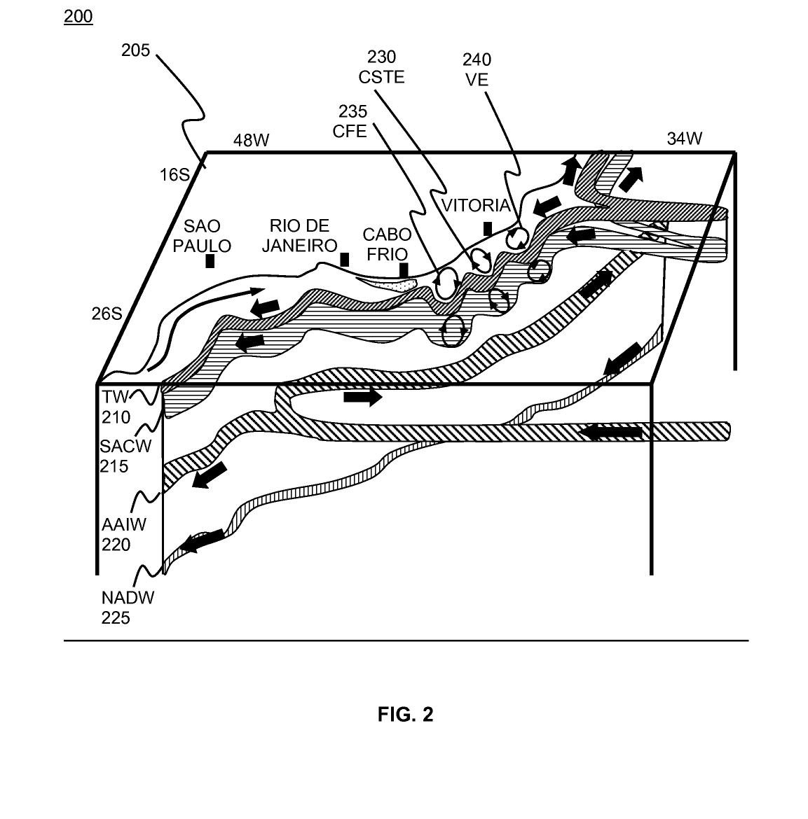

FIG. 2 is a diagram of oceanic circulation features 200 off of SEBRA 205. It should be noted that the Brazil Current (BC) transports both Tropical Water (TW) 210 and South Atlantic Central Water (SACW) 215 in the SEBRA 205 region. The Intermediate Western Boundary Current (IWBC) transports basically Antarctic Intermediate Water (AAIW) 220 northward while at abyssal depths. The Deep Western Boundary Current carries North Atlantic Deep Water (NADW) 225 poleward. The water mass characteristics of the eddies off of Cape São Tomé 230 and Cape Frio 235 and expectedly off of Vitória 240 set up this asymmetric configuration. The inshore part of the meander will have water masses closer to the upwelling region (relatively colder and fresher), while the offshore part of the eddy would have water masses akin to the shoreward side of the BC meander (relatively warmer and saltier).

The Gangopadhyay and Robinson formulation for a symmetric eddy was modified. In that parameterization, the edge temperature/salinity (T-S) profiles are uniform, a characteristic of the Gulf Stream rings. Therefore, for such symmetric eddies, the hydrographic property profiles are identical along the whole eddy edge. Varying T-S profiles are considered for the southeastern Brazil regional ocean by adopting the tracer formulation given by:

T(ρ,z,η)=Tₖ(z,θ)[1−exp(−r/R)]+T_{c}(z)exp(−r/R)

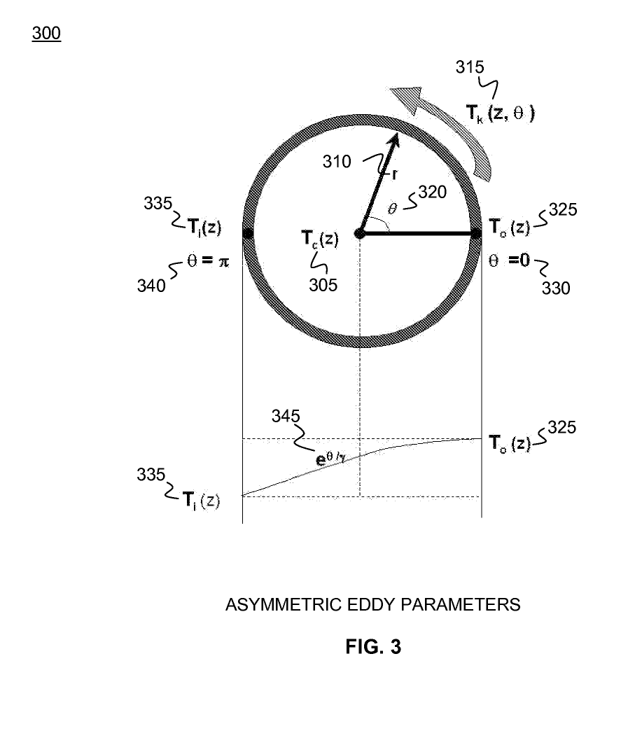

FIG. 3 depicts a schematic diagram 300 of asymmetric eddy parameters included in the above equation where T_{c}(z) 305 is the core profile input, r 310 is the distance between the center to the edge of the eddy and the distance e-folding scale R=3R_{d}, where R_{d} is the internal Rossby deformation radius. The chosen R value here roughly matches the eddy diameter. Tₖ(z, θ) 315 is the edge profile value. The edge profile value can be written as:

Tₖ(z,θ)=Tᵢ(z)+[(Tₒ(z)−Tᵢ(z))/2]exp(θ/γ)(1+cos θ)

where θ 320 ranges from 0 to 2π. Tₒ(z) 325 is the temperature/salinity profile of the offshore part of the eddy edge. The Tₒ(z) 325 position is established to be at θ=0 330 in the model. Tᵢ(z) 335 is the temperature/salinity profile of the inshore eddy edge part where θ=π 340. Hence, by such configuration, the location θ=0 330 along the eddy edge is where the highest temperature occurs (due to the Tₒ 325 profile). The function exp(θ/γ) 345 provides the azimuthal distribution between inshore and offshore edges of the eddy. In fact, the gradient between Tᵢ 335 and Tₒ 325 in the meander eddy upwelling system (MEUS) edge varies with this ‘‘asymmetry’’ function. Therefore, γ can be called the asymmetry parameter and determines how the exponential function azimuthally varies. If γ is a high positive value, temperature and salinity tend to vary linearly from Tₒ 325 and Tᵢ 335 along the edge. On the other hand, γ also establishes the percent contribution of coastal/South Atlantic Central Water (SACW) upwelling waters and oceanic waters within the eddy. If γ>0 as θ increases, Tₒ 325 contributes to a general warming of the eddy edge. Thus, through the γ parameter, one can also control how much warmer or colder the eddy is. The equation for Tₖ 315 can be applied to other oceanic regions as well.

For Gulf Stream eddies/rings, Tₖ 315 is uniform along the eddy edge and thus there is only one tracer profile in the background. However, in the case of southeastern Brazil (SEBRA), the tracer profiles on the edges of these eddies are not same. These meanders are located near the continental margin, and are influenced by upwelling and interaction with bathymetry. Thus, the eddy exhibits a horizontal temperature/salinity gradient between the coast and offshore. For example, in the Cape Frio Eddy FIG. 2, 235, the temperature profile near the coast (Tᵢ 335) is colder than that of offshore (Tₒ 325).

For an embodiment, a Mathworks′™ MATLAB computer program file interactively constructs the three-dimensional structure of the CFE and CSTE. MATLAB® is a registered trademark of Mathworks™. The interface design is user-friendly, expanding the number of potential operators. The program includes a validation procedure involving hydrographic data.

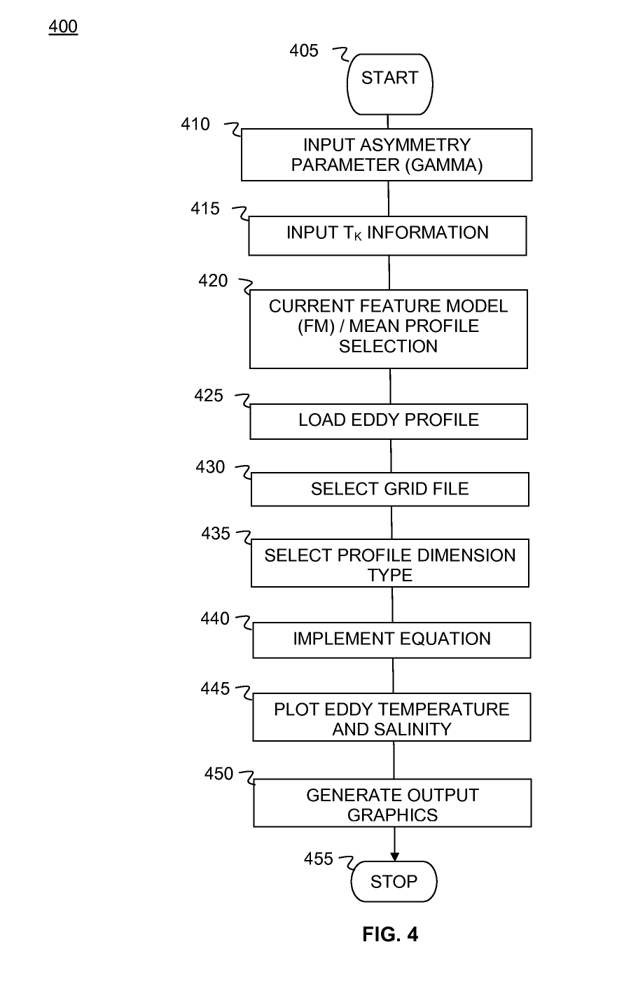

FIG. 4 is a flow chart 400 of a method for estimating asymmetric eddies employed by embodiments of the invention. The method comprises starting at 405; inputting asymmetry parameter (gamma) 410; inputting Tₖ edge profile information 415; selecting a feature model (FM) 420; in embodiments, the FM is a Brazil Current Feature Model (BCFM) or a mean profile; loading eddy profile 425; selecting grid file 430; selecting profile dimension type 435; implementing equation 440; plotting eddy temperature and salinity 445; and generating output graphics 450 to stopping 455.

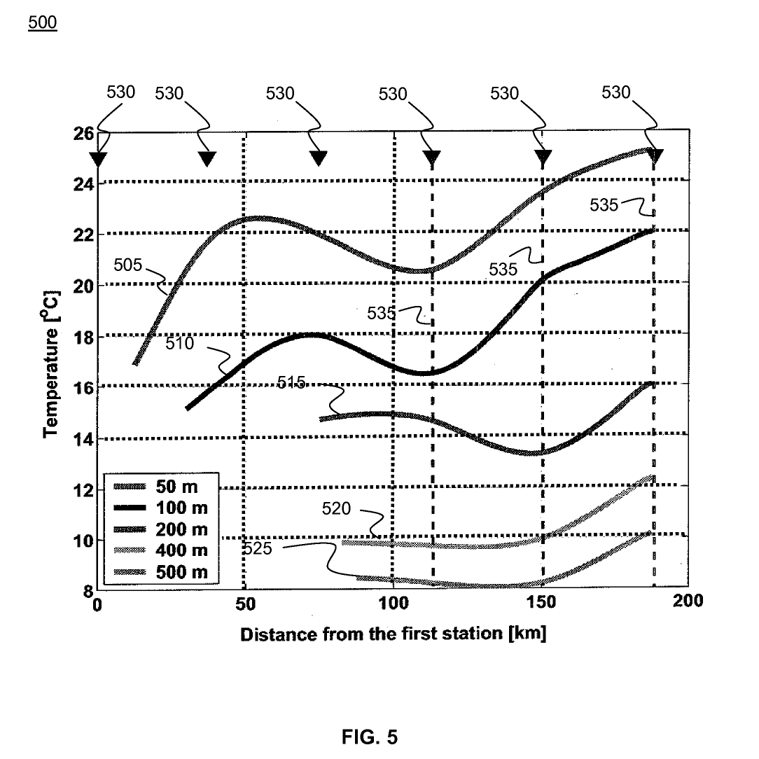

FIG. 5 is a graph 500 of temperature lines used to show an example eddy. Data was obtained from summer 2001 “Dinâmica do Ecossistema de Plataforma da Região Oeste do Atlântico Sul”—Ecosystem Dynamics of the Continental Shelf Region of the western South Atlantic (DEPROAS) temperature lines for 50 m 505, 100 m 510, 200 m 515, 400 m 520, and 500 m 525 (Jan. 6-9, 2001). The triangles 530 represent DEPROAS hydrographic stations. The dashed lines 535 indicate station data used to identify the possible eddy edges.

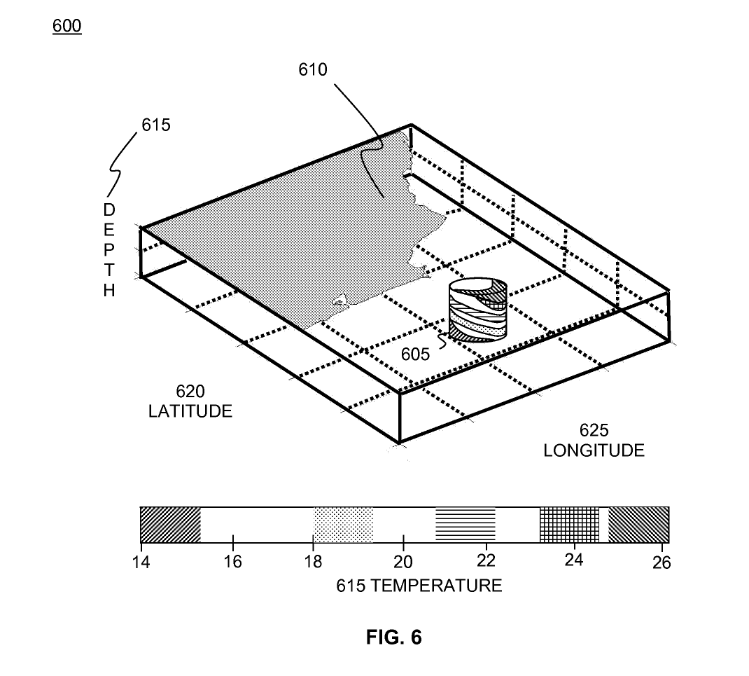

FIG. 6 illustrates an output 600 of results for an embodiment depicting the Cabo Frio Eddy (CFE). It presents a three-dimensional eddy FM temperature result for the CFE 605 off of SEBRA 610. Note the asymmetric temperature distribution within the eddy structure. Temperature scale 615 is in degrees Centigrade from 14 to 26. Latitude 620 in degrees from 20 S to 25 S, longitude 625 in degrees from 40 W to 44 W, and depth 630 in meters from 0 to 200, are depicted.

Embodiments describe or quantify the description of coastal eddies offshore from three specified profiles. Given the core and the shore (inshore and offshore) profiles, embodiments produce a three-dimensional eddy representation for a particular region. The asymmetric formulation provides a capability not available in previous symmetric eddy formulations.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A system for representing asymmetric eddy properties, said system comprising:
an input component that receives hydrographic property profiles comprising inshore, core, and offshore data;
a processing component that generates asymmetric eddy properties comprising temperature and salinity from said hydrographic property profiles; and
a display component that generates output of said asymmetric eddy properties.

2. The system of claim 1, wherein said hydrographic property profiles represent at least one region.

3. The system of claim 1, wherein said processing component comprises an eddy feature model (EFM).

4. The system of claim 1, wherein said processing component comprises a generalized tracer formulation.

5. The system of claim 1, wherein said processing component comprises asymmetry parameter gamma (γ).

6. The system of claim 5, wherein said asymmetry parameter gamma comprises seasonal variations.

7. The system of claim 5, wherein said asymmetry parameter gamma comprises regional variations.

8. The system of claim 4, wherein said generalized tracer formulation comprises a relationship T(ρ,z,θ)=Tₖ(z,θ)[1−exp(−r/R)]+T_{c}(z) exp(−r/R)

9. The system of claim 1, wherein said processing component comprises an internal Rossby deformation radius.

10. The system of claim 2, wherein said at least one region comprises southeastern Brazil (SEBRA).

11. The system of claim 2, wherein said at least one region comprises at least one of Cabo Frio Eddy (CFE), Cabo São Tomé Eddy (CSTE), and Vitória Eddy (VE).

12. The system of claim 2, wherein said at least one region comprises at least one of Gulf of Maine, Gulf of Alaska, Gulf of Mexico, Caribbean Sea, and Norwegian Sea.

13. The system of claim 1, wherein said generated output comprises a nowcast of said asymmetric eddy properties.

14. The system of claim 1, wherein said hydrographic property profiles comprise Ecosystem Dynamics of the Continental Shelf Region of the western South Atlantic (DEPROAS) data.

15. A method for representing asymmetric eddy properties, said method comprising the steps of:
providing asymmetry parameter gamma (γ);
providing edge profile information;
selecting a feature model (FM);
loading an eddy profile;
selecting a grid;
selecting profile dimension type;
implementing asymmetric eddy equation for said asymmetry parameter gamma (γ), said edge profile information, said feature model, said eddy profile, said grid, and said profile dimension type;
plotting eddy properties; and
generating output from said eddy properties.

16. The method of claim 15, comprising edge profile information given by Tₖ(z,θ)=Tᵢ(z)+[(Tₒ(z)−Tᵢ(z))/2]exp(θ/γ)(1+cos θ).

17. The method of claim 15, wherein said step of selecting a feature model (FM) comprises a Brazil current feature model (BCFM).

18. The method of claim 15, wherein said step of selecting a feature model (FM) comprises a mean profile.

19. The method of claim 15, wherein said generating output step comprises at least one of storing results for future retrieval, displaying results, and printing results.

20. A method for representing asymmetric eddy properties, said method comprising the steps of:
providing asymmetry parameter gamma (γ);
providing edge profile information comprising relationship Tₖ(z,θ)=Tᵢ(z)+[(Tₒ(z)−Tᵢ(z))/2]exp(θ/γ)(1+cos θ);
selecting a Brazil current feature model (BCFM);
loading an eddy profile;
selecting a grid file;
selecting profile dimension type;
implementing asymmetric eddy equation for said asymmetry parameter gamma (γ), said edge profile information, said Brazil current feature model, said eddy profile, said grid file, and said profile dimension type, wherein said implementing comprises a generalized tracer formulation T(ρ,z,θ)=Tₖ(z,θ)[1−exp (−r/R)]+T_{c}(z)exp(−r/R);
plotting eddy properties comprising temperature and salinity from said equation implementation; and
generating output comprising at least one of storing results for future retrieval, displaying results, and printing results.
